(19) United States
(12) Patent Application Publication
(10) Pub. No.: US 2019/0054464 A1
(43) Pub. Date: Feb. 21, 2019

(54) APPARATUS FOR SEPARATING MICRO-PARTICLES USING TRIANGULAR MICROCHANNEL

(71) Applicant: KOREA ADVANCED INSTITUTE OF SCIENCE AND TECHNOLOGY, Daejeon (KR)

(72) Inventors: Wonhee Lee, Daejeon (KR); Jeong-Ah Kim, Daejeon (KR)

(21) Appl. No.: 15/876,044

(22) Filed: Jan. 19, 2018

(30) Foreign Application Priority Data
Aug. 18, 2017 (KR) 10-2017-0104887

(51) Int. Cl. B01L 3/00

(52) U.S. Cl. CPC B01L 3/502715; B01L 3/502776; B01L 2300/08; B01L 2400/0463; B01L 2300/0809; B01L 2300/0858; B01L 2200/0647

(57) ABSTRACT

A micro-particle separation apparatus includes a triangular microchannel of which a cross-section is formed in the shape of a triangle and through which a fluid including a plurality of particles flows by a predetermined length; and an outlet that separates particles that have been arranged at different focusing positions in the triangular microchannel, and outputs the separated particles. The triangular microchannel has different focusing positions depending on particle size.

### CROSS-REFERENCE TO RELATED APPLICATION

This application claims priority to and the benefit of Korean Patent Application No. 10-2017-0104887 filed in the Korean Intellectual Property Office on Aug. 18, 2017, the entire contents of which are incorporated herein by reference.

### BACKGROUND

### (a) Field

The present invention relates to a method for separating micro-particles.

### (b) Description of the Related Art

Inertial focusing may be used for simple and passive micro-particle manipulation such as particle or cell separation, ordering, fluid exchange, cell analysis, and the like.

A method for separating particles by using inertial focusing in a rectangular channel having a rectangular cross-section has been disclosed (Di Carlo et al., 2009). However, locations of focusing positions are not significantly different from each other depending on particle size in the rectangular channel so that particles cannot be easily separated based on particle size. In order to solve such a problem, there is an example of forming a location difference based on particle size by inducing a Dean drag force through introduction of a curved channel. However, since the channel needs to be designed and manufactured while considering the Dean drag force that appears in the curved channel, it is still not easy to separate particles using a rectangular channel.

The above information disclosed in this Background section is only for enhancement of understanding of the background of the invention and therefore it may contain information that does not form the prior art that is already known in this country to a person of ordinary skill in the art.

### SUMMARY

The present invention provides an apparatus that can separate micro-particles of various sizes through a triangular microchannel where alignment of focusing positions is changed depending on particle size, and a method thereof.

In addition, the present invention provides an apparatus that can separate micro-particles of various sizes through a triangular microchannel where alignment of focusing positions is changed depending on the Reynolds number.

According to an exemplary embodiment, a micro-particle separation apparatus includes: a triangular microchannel of which a cross-section is formed in the shape of a triangle and through which a fluid including particles with a plurality of sizes flows by a predetermined length; and an outlet that separates the particles that have been arranged at different focusing positions in the triangular microchannel, and outputs the separated particles. The triangular microchannel makes different focusing positions depending on particle size.

In the triangular microchannel, focusing positions may shift along two side walls from the top corner of the cross-section of the channel as the particle size is decreased.

In the triangular microchannel, the particles may be focused above and below the center of the cross-section of the channel depending on particle size or focused near each side wall of the triangular microchannel.

In the triangular microchannel, focusing position of particles with a specific size may shift along two side walls from the top corner of the cross-section of the channel as a Reynolds number is increased.

The Reynolds number may be changed by adjusting at least one of velocity of the fluid having flowed into the triangular microchannel, fluid density, fluid viscosity, and a size of the triangular microchannel.

The Reynolds number may be determined for separating target particles with a specific size among the particles with the plurality of sizes through the outlet. Focusing position of the target particles may become different from focusing positions of other-sized particles among the particles with the plurality of sizes by the determined Reynolds number.

According to an exemplary embodiment, a micro-particle separation apparatus includes: a rectangular microchannel of which a cross-section is formed in the shape of a rectangle and through which a fluid including particles with a plurality of sizes flows by a predetermined length; and a triangular microchannel of which a cross-section is formed in the shape of a triangle, and connected with the rectangle-shaped microchannel such that the fluid having passed through the rectangular microchannel is flowed thereinto. The rectangular microchannel makes focusing positions of the particles along parallel side walls, and the triangular microchannel changes focusing positions of the particles depending on particle size.

The focusing positions may shift along two side walls from the top corner of the cross-section of the triangular microchannel as the particle size is decreased.

The focusing positions of the particles in the triangular microchannel may be above and below the center of the cross-section of the triangular microchannel or near each side wall of the triangular microchannel, depending on particle size.

The focusing position of the particles may shift along two side walls from the top corner of the cross-section of the triangular microchannel as a Reynolds number is increased.

The Reynolds number may be changed by adjusting at least one of velocity of the fluid having flowed into the triangular microchannel, fluid density, fluid viscosity, and a size of the triangular microchannel.

The micro-particle separation apparatus may further include an outlet that separates the particles that have been arranged at different focusing positions in the triangular microchannel and outputs the separated particles. The Reynolds number may be determined for separating target particles with a specific size among the particles with the plurality of sizes through the outlet. And focusing position of the target particles may become different from focusing positions of other-sized particles among the particles with the plurality of sizes by the determined Reynolds number.

According to the exemplary embodiments, the apparatus including the triangular microchannel controls alignment of focusing positions of particles based on particle size or a Reynolds number, and separates the particles.

According to the exemplary embodiments, it is possible to manually control the alignment of focusing positions by combining microchannels having various cross-sectional shapes with the triangular microchannel. It is possible to separate the particles without any active element.

According to the exemplary embodiment, it is possible to provide a small-sized micro-particle separation apparatus having a simple structure by using inertial focusing of the triangular microchannel.

### BRIEF DESCRIPTION OF THE DRAWINGS

FIG. 1 describes inertial focusing according to an exemplary embodiment.

FIG. 2 conceptually describes variation of focusing positions according to particle sizes and Reynolds number in the triangular microchannel according to an exemplary embodiment.

FIG. 3 shows an example of the triangular microchannel according to an exemplary embodiment.

FIG. 4 shows top view of the triangular microchannel according to an exemplary embodiment.

FIG. 5 shows focusing positions that vary depending on particle size and Reynolds number in the triangular microchannel according to an exemplary embodiment.

FIG. 6 shows a micro-particle separation apparatus according to an exemplary embodiment.

FIG. 7 shows graphs that represent separation results of the micro-particle separation apparatus according to an exemplary embodiment.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements.

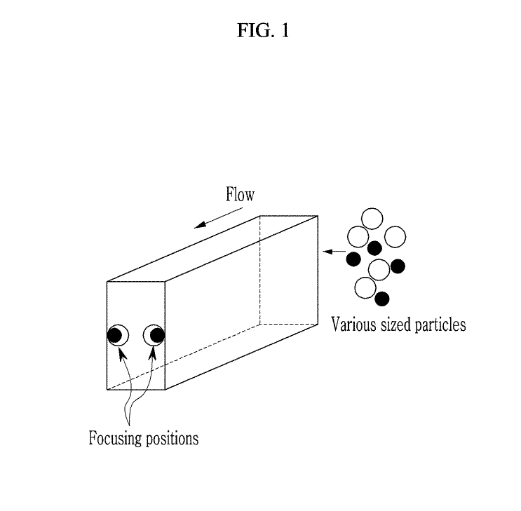

FIG. 1 describes inertial focusing according to an exemplary embodiment.

Referring to FIG. 1, when the fluid including micro-particles flows, a focusing position of particles is formed at a position where two types of inertial lift forces are balanced. The two types of inertial lift forces include a shear-gradient lift force and a wall effect lift force.

The fluid flows faster at the center of the channel and slower near the wall of the channel. Thus, the shear-gradient lift force is generated by velocity variation in the channel when the fluid flows inside the channel. The shear-gradient lift force acts to push the particles toward the wall from the center of the channel.

The wall effect lift force is generated by hydrodynamic interactions between the wall and the particles. The wall effect lift force acts to push the particles to the center of the channel from the wall. The particles are focused at equilibrium positions of the two lift forces.

However, although focusing positions are formed in the rectangular microchannel, locations of the focusing positions are not significantly different from each other according to particle sizes. Thus, it is not easy to separate particles of various sizes included in the fluid through the rectangular microchannel.

Hereinafter, it is described that an apparatus separates micro-particles having various sizes through a triangular microchannel which changes focusing positions of the particles depending on particle size.

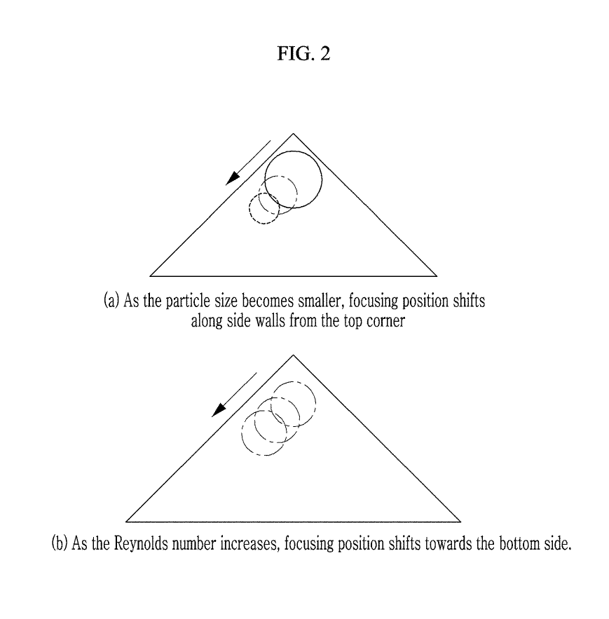

FIG. 2 conceptually describes variation of focusing positions according to particle sizes and Reynolds number in the triangular microchannel according to an exemplary embodiment.

Referring to FIG. 2, when a cross-sectional shape of the channel is changed, a flow velocity profile of the channel is changed, and the magnitude and direction of the inertial force due to the shear gradient are changed. Accordingly, the wall effect lift force is changed.

Referring to (a) of FIG. 2, particles migrate in a triangular microchannel surrounded by three walls, and thus equilibrium positions at which the particles are focused are changed based on particle size. As the particle size becomes smaller, the focusing positions shift down along the side walls from the top corner of the triangular microchannel. Thus, since the focusing positions are changed according to particle sizes in the triangular microchannel, particles of various sizes can be separated.

Referring to (b) of FIG. 2, focusing position at which inertial forces are in equilibrium are changed depending on the Reynolds number in the triangular microchannel. Even the particles are the same in size, focusing positions shift towards the bottom side from the top corner of the triangular microchannel, as the Reynolds number increases. Thus, a focusing position of a specific particle can be varied by changing the Reynolds number in the triangular microchannel.

The Reynolds number (Re) can be calculated as given in Equation 1, and it can be changed by adjusting average velocity of the fluid and the channel size.

$$Re = \frac{ρ UH}{μ} \qquad [ Equation 1 ]$$

In Equation 1, ρ denotes density of the fluid, U denotes average velocity, H denotes a hydraulic diameter, and μ denotes viscosity.

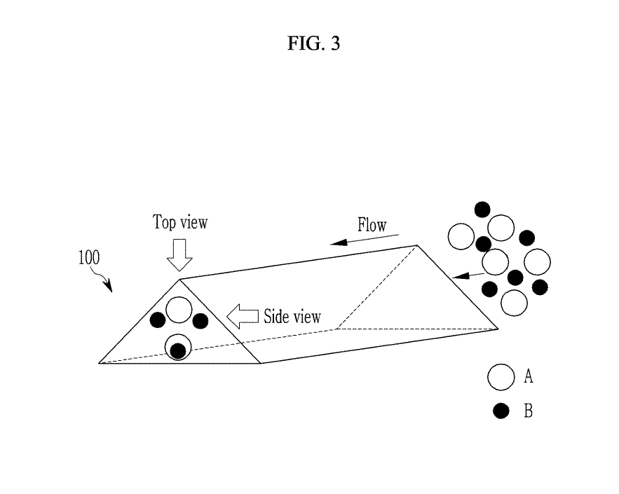

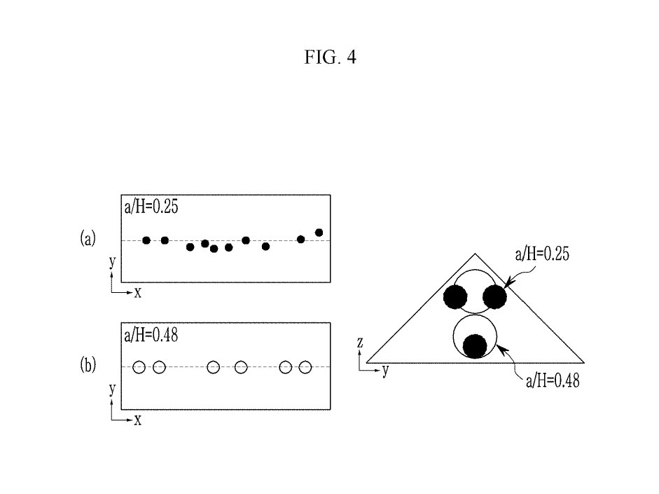

FIG. 3 shows an example of the triangular microchannel according to an exemplary embodiment, and FIG. 4 shows top view of the triangular microchannel according to an exemplary embodiment.

Referring to FIG. 3, micro-particles of various sizes flow along the triangular microchannel 100, and alignment of focusing positions is changed depending on particle size. That is, locations and numbers of the focusing positions are changed depending on particle size.

For example, in case of larger particles A, the larger particles A may be focused at two positions, i.e., above and below the center of the channel (i.e., the vertex and the lower center) when viewed from the cross-section of the triangular microchannel. In case of smaller particles B, the smaller particles B may be focused at three positions near each side of the cross-section of the triangular microchannel.

Viewed from the top of the triangular microchannel, the larger particles A are focused at two positions of above and below the center of the channel, and thus the particles are aligned in one inertial focusing line and move along the channel. Since the smaller particles B are focused at three positions near each side of the cross-section of the triangular microchannel, the smaller particles B may be aligned in three inertial focusing flow lines and move with a slight symmetric deviation from the center.

Viewed from the side view of the triangular microchannel, the larger particles A are aligned into two lines, and the smaller particles B are also aligned into two.

Referring to FIG. 4, (a) shows movement of smaller particles (a/H=0.25, a denotes a particle diameter, and H denotes a hydraulic diameter) viewed from the top of the triangular microchannel 100, and (b) shows movement of larger particles (a/H=0.48) viewed from the top of the triangular microchannel 100.

In top view (a), the particles move with a deviation at the center because the particles move along the focusing position formed at each side of the triangular microchannel.

In top view (b), the particles move while being aligned in one line at the center because the particles move along the focusing positions formed above and below the center of the triangular microchannel.

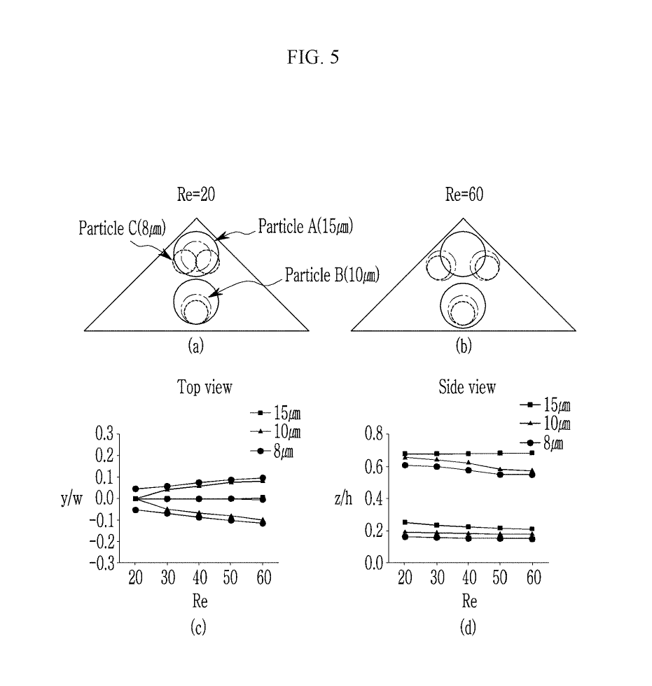

FIG. 5 shows focusing positions that vary depending on particle size and Reynolds number in the triangular microchannel according to an exemplary embodiment.

Referring to FIG. 5, focusing position alignment is changed depending on particle size in the triangular microchannel. It is assumed that the size of the particles A (e.g., 15 μm), the particles B (e.g., 10 μm), and the particles C (e.g., 8 μm) are smaller in this order.

Referring to cross-section (a) of FIG. 5, when the Reynolds number is 20, the particles A and the particles B, which are larger particles, are focused at two positions at the center of the channel, and the particles C are focused at three positions near the each channel wall.

Referring to cross-section (b) of FIG. 5, when the Reynolds number is 60, the larger particles A are still focused at two positions of the center of the channel, and the particles B and the particles C are focused at positions gradually nearer three sides of the channel.

Graph (c) of FIG. 5 shows variation of focusing positions of particles viewed from top. In the Graph (c), the title of the X-axis is the Reynolds number (Re) and the title of the Y-axis is y position in the width of the channel (y/w). Graph (d) of FIG. 5 shows variation of focusing positions of particles viewed from side. In the Graph (d), the title of the X-axis is the Reynolds number (Re) and the title of the Y-axis is z position in the height of the channel (z/h).

In case of the smaller particles C (8 μm), referring to (c) of FIG. 5, which is the top view of the triangular microchannel, the particles are focused at three positions in the entire Reynolds number, and referring to (d) of FIG. 5, which is the side view of the triangular microchannel, the particles are focused at two positions in the entire Reynolds number range. Thus, it can be determined that the particles C (8 μm) are focused at three positions in the entire Reynolds number range.

In case of the larger particles A (15 μm), referring to (c) of FIG. 5, which is the top view of the triangular microchannel, the particles A are focused at one position in the entire Reynolds number range, and referring to (d) of FIG. 5, which is the side view of the triangular microchannel, the particles A are focused at two positions in the entire Reynolds number range. Thus, it can be determined that the particles A (15 μm) are focused at two positions in the entire Reynolds number range.

In case of the middle-sized particles B (10 μm), referring to (c) of FIG. 5, which is the top view of the triangular microchannel, the particles B are focused at one position when the Reynolds number is 20, and the particles B are focused at three positions when the Reynolds number is increased. Referring to (d) of FIG. 5, which is the side view of the triangular microchannel, two focusing positions are formed in the entire Reynolds number range. Thus, it can be determined that the particles B (10 μm) are focused at two positions when the Reynolds number is 20, and the number of focusing positions is increased when the Reynolds number is increased.

As described, since the alignment of focusing position is changed depending on particle size and Reynolds number in the triangular microchannel, a specific-sized particle can be selectively separated. For example, when different-sized particles A (15 μm), B (10 μm), and C (8 μm) are included in the fluid and the particles C (8 μm) need to be separated, the particles C can be separated from the other-sized particles A and B by adjusting the Reynolds number to 20. When the Reynolds number is adjusted to be greater than 20 (e.g., 60), the particles A (15 μm) can be separated from the other sized particles.

Referring to Equation 1, the Reynolds number can be calculated by using several variables, but the Reynolds number can be changed by adjusting average velocity of the fluid or adjusting channel size.

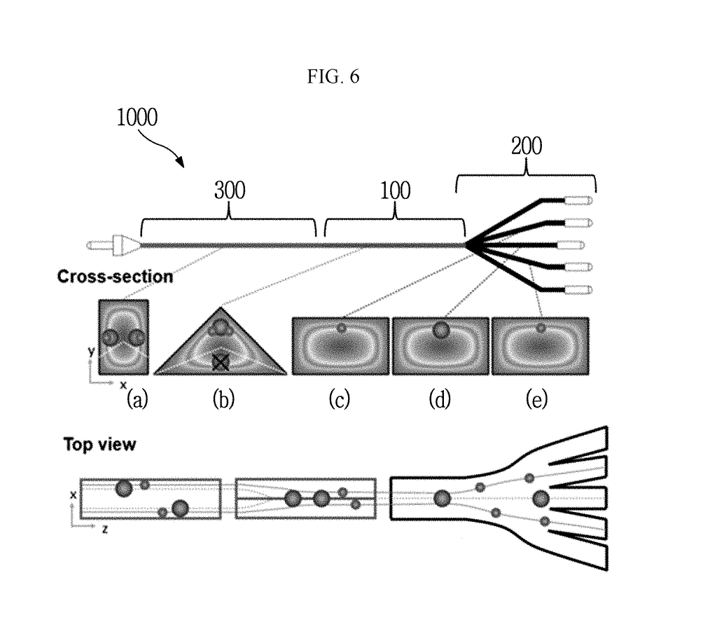

FIG. 6 shows a micro-particle separation apparatus according to an exemplary embodiment.

Referring to FIG. 6, a micro-particle separation apparatus 1000 includes at least one triangular microchannel 100 and an outlet 200 where particles flowing at different focusing positions in the triangular microchannel 100 are separated. The outlet 200 can be separated into a plurality of outlet channels (e.g., five outlets) depending on the number of focusing positions (focusing flow lines). In addition, the micro-particle separation apparatus 1000 arranges a channel 300 that limits inflow of particles to a location where focusing positions are overlapped ahead of the triangular-shape microchannel 100, and connect the channel 300 and the triangular microchannel 100 in consideration of focusing position alignment of various-sized particles in the triangular microchannel 100. The channel 300 that limits inflow of the particles to the location where the focusing positions are overlapped may be a rectangular microchannel.

For example, when two different types of particles are randomly flowed into the triangular microchannel 100, the two types of particles are focused as shown in (b) in the triangular microchannel 100. In this case, since the focusing positions are overlapped in the bottom side of the triangular microchannel 100, the particles cannot be separated.

In this case, as described with reference to FIG. 1, in the rectangular microchannel 300, the particles are focused at positions near side walls of the rectangular microchannel 300 as shown in (a) regardless of particle size. If the two types of particles that are different in size flow from the rectangular microchannel 300 to the triangular-shape microchannel 100, the particles arranged along parallel side walls in the rectangular microchannel 300 are focused upward in the triangular microchannel 100 by inertial forces. Thus, focusing positions of the particles are not formed in the bottom side of the triangular microchannel 100. This is because the microchannel is divided into a plurality of basins of attraction in a cross-section and the particles moved in certain basin are focused in the corresponding basin. When no particles are flowed into basin areas that occupy the bottom side of the channel, focusing positions of the particles are not occupied in the bottom side of the channel.

Since the focusing positions are formed at the upper center and near side walls of the triangular microchannel 100, particles are separated according to particle size and output to each channel of the outlet 200 as described in (c), (d) and (e) of FIG. 6.

In a top view, the particles move through the flow lines formed along the side walls of the rectangular microchannel 300, and then move through the flow lines separated to the center and side walls according to particle size in the triangular microchannel 100. Finally, the particles moved along the respective flow lines are output to the respective channels of the outlet 200.

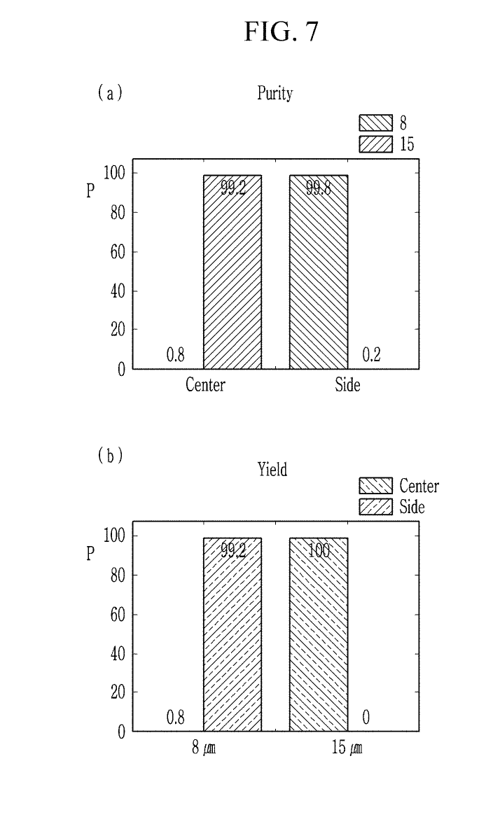

FIG. 7 shows graphs that represent separation results of the micro-particle separation apparatus according to an exemplary embodiment.

Graph (a) of FIG. 7 shows separation result of two different sizes with high purity, when 8 μm particles and 15 μm particles are flowed into the micro-particle separation apparatus 1000. The result shows that 99.2% of the 15 μm particles reach the center channel of the outlet 200 and 99.8% of the 8 μm particles reach the side channels of the outlet 200 (Re=60).

Graph (b) of FIG. 7 shows separation result of two different sizes with high yield, when 8 μm particles and 15 μm particles are flowed into the micro-particle separation apparatus 1000. The result shows that 99.2% of the 8 μm particles are separated at the side channels of the outlet 200 and 100% of the 15 μm particles are separated at the center channel of the outlet 200 (Re=60).

As described, the micro-particle separation apparatus 1000 can separate particles with different sizes, and therefore it can be used in particle separation or cell separation in a chemical process. In particular, the micro-particle separation apparatus 1000 can separate 8 μm particles and 10 μm particles, which correspond to a cell size, by adjusting the Reynolds number.

According to the exemplary embodiment, alignment of focusing positions can be controlled according to particle size or Reynolds number through the triangular microchannel, and accordingly, particles can be separated therethrough. According to the exemplary embodiment, the alignment of focusing positions can be manually controlled without an active element by combining a microchannel having various cross-sectional shapes with the triangular microchannel, and accordingly particles can be separated therethrough. According to the exemplary embodiment, inertial focusing of the triangular microchannel is used, and thus a small-sized micro-particle separation apparatus having a simple structure can be provided.

The exemplary embodiments of the present invention described above can be implemented not only through the apparatus and the method, but can also be implemented through a program which realizes a function corresponding to a configuration of the exemplary embodiments of the present invention or a recording medium having the program recorded therein.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A micro-particle separation apparatus comprising:
a triangular microchannel of which a cross-section is formed in the shape of a triangle and through which a fluid including particles with a plurality of sizes flows by a predetermined length; and
an outlet that separates the particles that have been arranged at different focusing positions in the triangular microchannel, and outputs the separated particles ,
wherein the triangular microchannel makes different focusing positions depending on particle size.

2. The micro-particle separation apparatus of claim 1, wherein, in the triangular microchannel, focusing positions shift along two side walls from the top corner of the cross-section of the channel as the particle size is decreased.

3. The micro-particle separation apparatus of claim 2, wherein, in the triangular microchannel, the particles are focused above and below the center of the cross-section of the channel depending on particle size or focused near each side wall of the triangular microchannel.

4. The micro-particle separation apparatus of claim 1, wherein, in the triangular microchannel, focusing position of particles with a specific size shifts along two side walls from the top corner of the cross-section of the channel as a Reynolds number is increased.

5. The micro-particle separation apparatus of claim 4, wherein the Reynolds number is changed by adjusting at least one of velocity of the fluid having flowed into the triangular microchannel, fluid density, fluid viscosity, and a size of the triangular microchannel.

6. The micro-channel separation apparatus of claim 4, wherein the Reynolds number is determined for separating target particles with a specific size among the particles with the plurality of sizes through the outlet, and focusing position of the target particles becomes different from focusing positions of other-sized particles among the particles with the plurality of sizes by the determined Reynolds number.

7. A micro-particle separation apparatus comprising:
a rectangular microchannel of which a cross-section is formed in the shape of a rectangle and through which a fluid including particles with a plurality of sizes flows by a predetermined length; and
a triangular microchannel of which a cross-section is formed in the shape of a triangle, and connected with the rectangle-shaped microchannel such that the fluid having passed through the rectangular microchannel is flowed thereinto,
wherein the rectangular microchannel makes focusing positions of the particles along parallel side walls, and
the triangular microchannel changes focusing positions of the particles depending on particle size.

8. The micro-particle separation apparatus of claim 7, wherein the focusing positions shift along two side walls from the top corner of the cross-section of the triangular microchannel as the particle size is decreased.

9. The micro-particle separation apparatus of claim 7, wherein the focusing positions of the particles in the triangular microchannel are above and below the center of the cross-section of the triangular microchannel or near each side wall of the triangular microchannel, depending on particle size.

10. The micro-particle separation apparatus of claim 7, wherein the focusing position of the particles shifts along two side walls from the top corner of the cross-section of the triangular microchannel as a Reynolds number is increased.

11. The micro-particle separation apparatus of claim 10, wherein the Reynolds number is changed by adjusting at least one of velocity of the fluid having flowed into the triangular microchannel, fluid density, fluid viscosity, and a size of the triangular microchannel.

12. The micro-particle separation apparatus of claim 11, further comprising
an outlet that separates the particles that have been arranged at different focusing positions in the triangular microchannel and outputs the separated particles,
wherein the Reynolds number is determined for separating target particles with a specific size among the particles with the plurality of sizes through the outlet, and focusing position of the target particles becomes different from focusing positions of other-sized particles among the particles with the plurality of sizes by the determined Reynolds number.
